(19) United States
(12) Patent Application Publication
(10) Pub. No.: US 2002/0100858 A1
(43) Pub. Date: Aug. 1, 2002

(54) Encapsulation of metal heating/cooling lines using double nvd deposition

(76) Inventor: Reinhart Weber, Midland (CA)

Correspondence Address: Arne I. Fors, Gowling Lafleur Henderson LLP, Suite 4900, Commerce Court West, Toronto, ON, M5L 1J3, CA

(21) Appl. No.: 09/770,617

(22) Filed: Jan. 29, 2001

(51) Int. Cl. B29C 33/04; B23P 17/00

(52) U.S. Cl. 249/80; 249/116; 29/527.2

(57) ABSTRACT

A double-shell nickel mold produced by nickel vapor depositoin. A first nickel shell is deposited on a mandrel, heating/cooling lines are attached to the first nickel shell, a thermally-conductive filler is applied to fill all gaps between the heating/cooling lines and the first nickel shell, and a second nickel shell is deposited on the first nickel shell to encapsulate the heating/cooling lines.

### BACKGROUND OF THE INVENTION

(i) Field of the Invention

This invention relates to a nickel shell mold and, more particularly, relates to a nickel shell mold produced by nickel vapor deposition.

(ii) Description of the Related Art

It is known to deposit nickel shells on steel or aluminum alloy mandrels by nickel vapor deposition. U.S. Pat. No. 5,169,549 granted Dec. 8, 1992 discloses a method for the manufacture of nickel shells by vapor deposition of nickel from gaseous nickel carboxyl, incorporated herein by reference. U.S. Pat. No. 5,750,160 granted May 12, 1998, the disclosure of which is also incorporated herein by reference, discloses a method for forming a nickel shell on a steel base composition insert.

Nickel shell molds conventionally are heated/cooled by flood heating, whereby a hot or cold fluid is passed over the back of the shell between the shell and a pressure tight “jacket”; by air heating, in which nickel shell molds have heated air forced over the back at high volume; and by conduction, in which the nickel shell is clamped to a plate or backing assembly and heated/cooled by internal fluid channels in the plate or backing assembly. Another conduction method involves attaching a network of metal heating lines by welding or brazing, or by potting the metal lines to the nickel shell into a metal filled-epoxy backing.

### SUMMARY OF THE INVENTION

It is a principal object of the present invention to provide a method for encapsulating metal heating/cooling lines onto the back of a nickel shell using the nickel vapor deposition process and to provide an improved double nickel shell mold.

In its broad aspect, the method of the invention for forming double nickel shell mold comprises depositing a first nickel shell on a mandrel having a desired mold shape by nickel vapor deposition, whereby the first nickel shell acquires the shape of the mandrel, bending at least one fluid line to the shape of the nickel shell and attaching said fluid line to the first shell, and depositing a second nickel shell onto the first nickel shell for encapsulating the at least one fluid line between the first and second nickel shells. The fluid line preferably is a copper or stainless steel tube. The method additionally comprises filling any cavity or gap between the fluid line and the first nickel shell with a thermoplastic filler consisting of a mixture of at least one of particulate copper, aluminum, steel shot or powder in a polymer matrix selected from the group consisting of silicones, epoxies, urethanes, fluoropolymers and acrylics.

The nickel shell mold of the invention comprises a first nickel shell conformed to a desired shape by nickel vapor deposition; at least one fluid line for carrying a heat transfer fluid attached to the first nickel shell; and a second nickel shell deposited by nickel vapor deposition onto the first nickel shell encapsulating said at least one fluid line between the double nickel shells. Any space defined between the first nickel shell and the fluid line is substantially filled with a thermally conductive filler comprising a mixture of at least one of particulate copper, aluminum, steel shot or powder in a polymer matrix selected from the group consisting of silicones, epoxies, urethanes, fluoropolymers and acrylics.

### BRIEF DESCRIPTION OF THE DRAWINGS

The method of the invention and the product produced thereby will now be described with reference to the accompanying drawings, in which:

FIG. 1 is a fragmentary view of a cross-section of a first nickel shell deposition on a mandrel;

FIG. 2 is a fragmentary view corresponding to FIG. 1 showing heating/cooling tubes mounted on the first nickel shell;

FIG. 3 is a fragmentary view corresponding to FIG. 2 showing a second nickel shell deposition on the first nickel shell;

FIG. 4 is a plan view of a nickel shell of the invention incorporating in a heating and cooling system;

FIG. 5 is an enlarged fragmentary plan view of a portion of encapsulated heating/cooling tube taken along line 5-5 of FIG. 4;

FIG. 6 is a section taken along line 6-6 of FIG. 5, corresponding to the first nickel shell deposition of FIG. 1;

FIG. 7 is a section taken along line 6-6 of FIG. 5 showing a welded anchor;

FIG. 8 is a section taken along line 6-6 of FIG. 5 corresponding the second nickel deposition of FIG. 3; and

FIG. 9 is a section taken along line 9-9 of FIG. 5 corresponding to first nickel shell deposition of FIG. 1.

### DESCRIPTION OF THE PREFERRED EMBODIMENT

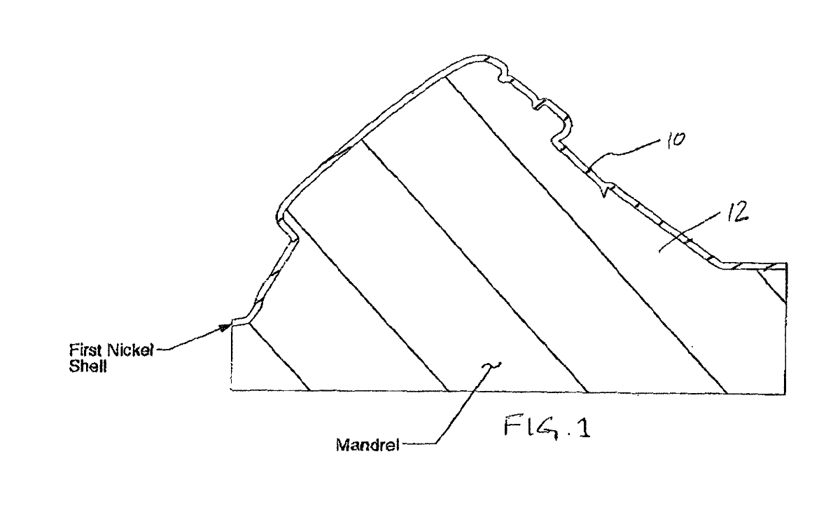

With reference to FIG. 1, a first nickel shell 10 is shown deposited by nickel vapor deposition onto mandrel 12. Mandrel 12 has the desired shape and texture of a product to be produced, such as by rotational molding, which is to be replicated in first nickel shell 10. Nickel vapor in the form of nickel carbonyl gas is passed over a heated mandrel in a deposition chamber and, as the nickel carbonyl gas contacts the hot mandrel surface, it decomposes to form a hard and dense nickel deposit. The deposited nickel as a layer accurately reproduces the surface details of the mandrel on which it is deposited. The nickel layer is uniformly deposited on the mandrel, regardless of shape, hereby producing adequate thickness in irregular shapes such as at sharp corners. The nickel is deposited at a rate of about 0.025 centimeter (0.1 inch) per hour in the deposition chamber at a temperature of about 177° C. (350° F.) to form the nickel shell.

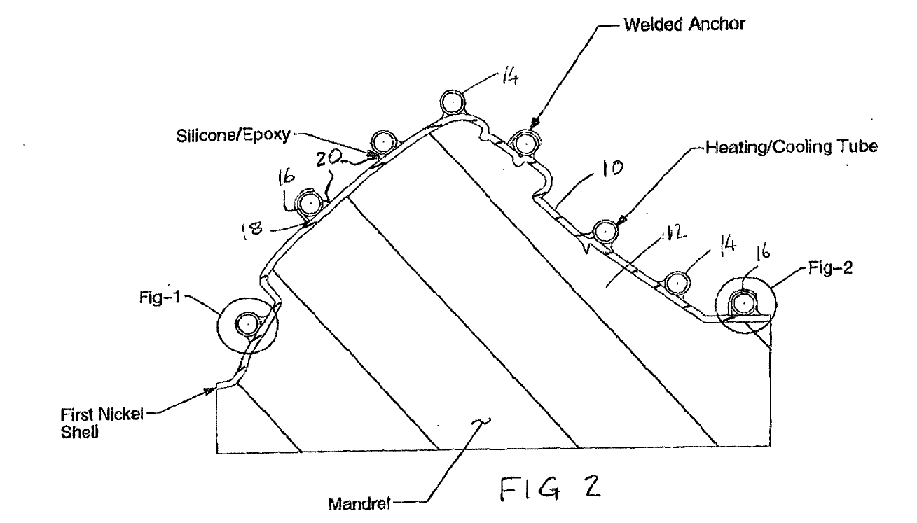

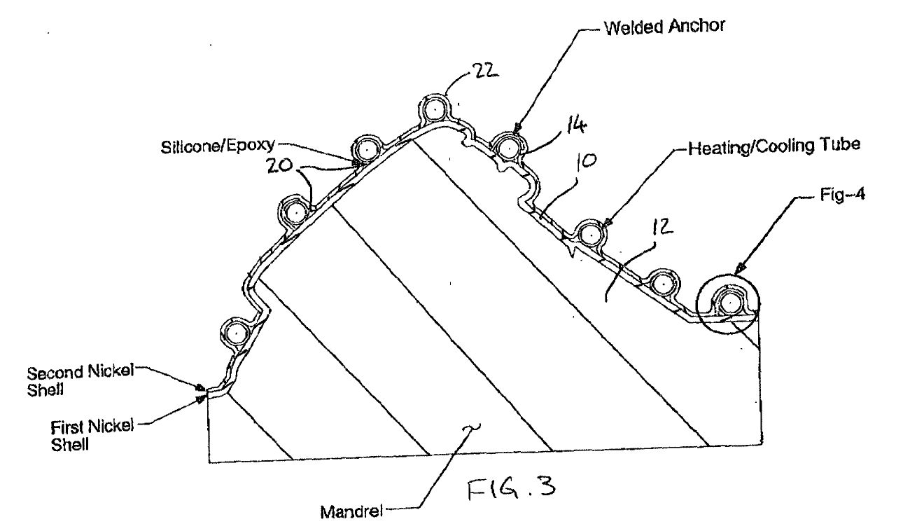

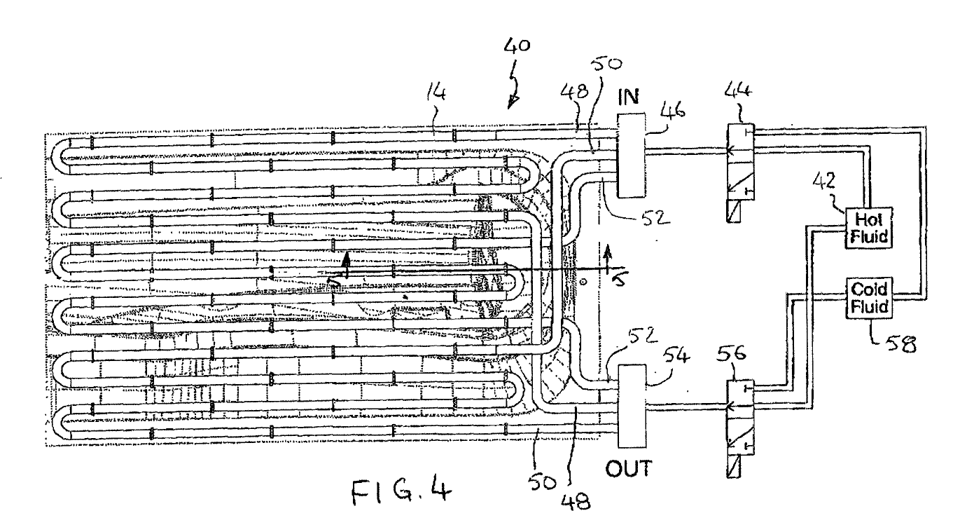

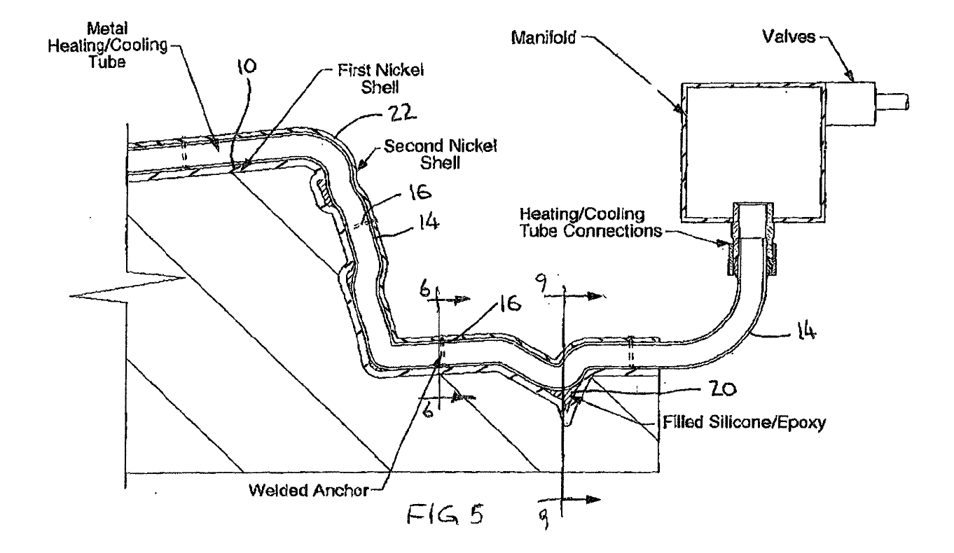

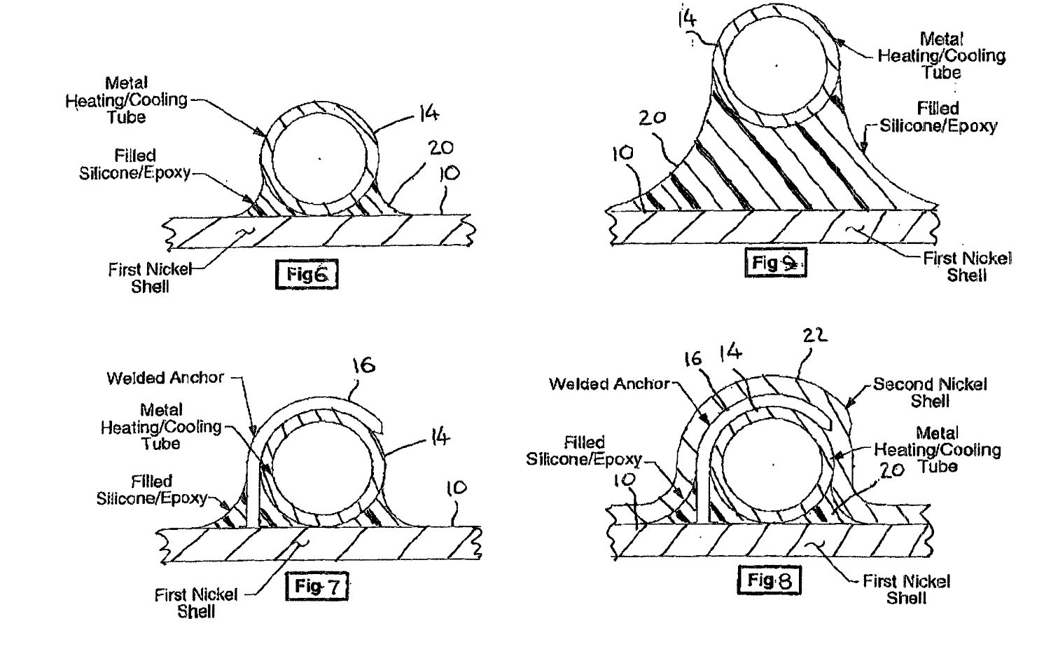

Uniformly-spaced heating/cooling tubes 14 such as copper or stainless steel tubes are placed on shell 10 and bent to closely follow the contours of the shell. FIG. 2 shows heating/cooling tubes 14 attached to first nickel shell 10 by bent wire or nail anchors 16 secured to shell 10 such as by steel-welding the proximal ends of the wire or nails to the shell at 18 and bending the distal ends of the wire or nail over the tubes. A typical tube pattern is disclosed in FIG. 4, to be described.

A mixture of silicone, epoxy or the like material 20 such as urethanes, fluoropolymers or acrylics, filled with high thermal conductivity copper, aluminum and/or thermally conductive steel shot or powder, is used to fill the space between the metal tubes and the nickel shell, as shown most clearly in FIGS. 6 and 9. The high thermal conductivity material 20 is used to fill every gap, eliminating any voids such as shown in FIGS. 5 and 9. The effective contact area between the tubes and the nickel shell is improved, enhancing the rate of heat transfer and improving the temperature uniformly across the nickel shell.

The assembly as shown in FIG. 2 is cleaned and off-gassed by heating to over 180° C. until no vapors are discharged from the assembly. The assembly is then returned to the nickel vapor deposition chamber and a second nickel shell 22 is deposited directly onto the first nickel shell and heating/cooling tubes 14 and onto the anchors 16 with filler material 20. The second nickel shell 22 is deposited uniformly onto the first shell 10 to encapsulate the metal heating/cooling lines and the welded anchors without creation of localized thinning or cleavage at the interface between the tubes 14 and the first shell 10, as illustrated in FIG. 3.

The double-nickel shell, complete with encapsulated heating/cooling lines is stripped from the mandrel.

With reference now to FIG. 4, a typical pattern of heating/cooling tubes is shown encapsulated in a double-nickel shell 40. Hot fluid from pump 42 passes through valve assembly 44 to intake manifold 46 for distribution to three parallel tube sections 48, 50 and 52. Exhaust manifold 54 receives the spent fluid which is directed to valve assembly 56 and back to pump 42. Cooling fluid in like manner is pumped from pump 58 through valve assembly 44 and then through the nickel shell 40 in the manner described for the heating fluid.

The apparatus of the present invention provides a number of important advantages.

The double-nickel shell of the invention is preferable to apparatus for flood heating in that during the molding cycle, and during the pre-heating of the mold, the amount of fluid passed across the back of the nickel shell is significantly reduced. The molding machine, which suplies heating fluid to the mold, can be designed with a valve system to supply hot fluid to the mold heating circuit, or cold oil to the same circuit for cooling, as illustrated in FIG. 4. The molding system thus is required to heat or cool only the heating fluid contained in the encapsulated metal lines.

The associated energy costs, hence operating costs, are therefore much lower. The molding machinery is also significantly less expensive than with flood heating, as the machinery can be designed to handle much lower fluid volumes.

The amount of heating fluid contained in the mold is significantly lower than one heated/cooled by flood heating, hence the weight of the mold is significantly lower and the machinery can be simpler and lighter and will be exposed to much lower mechanical stresses.

The double-nickel shell is preferable for use in rotational molding, as the mold temperature can be raised to the desired temperature without the need for a furnace, resulting in a significant savings in capital costs. A simple closed-loop, fluid-heating system replaces the furnace. Operating costs are reduced as the energy is used strictly to heat up the mold and the plastic powder, not the atmosphere in the furnace. Operating logistics are also simplified and costs are reduced as the molds can be run individually, not in batches as required for a furnace.

The double-nickel shell is superior to designs utilizing a separate heating/cooling plate as the metal lines are attached directly to and incorporated into the back of the mold face. The heat does not flow through an intermediate material, or through the additional interface required for a heating plate. The double-nickel shell concept provides better heat transfer and more uniform heat transfer than designs using filled-epoxy potting mixtures. This is because the second nickel shell transfers heat to or from the entire circumference of the metal tubing, not just from the contact between the tubing and the first shell. Nickel is also a much superior thermal conductor to metal-filled epoxies.

The double-nickel shell design eliminates the need to braze or weld metal lines to the back of a nickel shell, eliminating the distortion, shrinkage and softening associated with this process. This results in a higher quality mold tool and therefore higher quality molded parts.

It will be understood, of course, that modifications can be made in the embodiments of the invention described herein without departing from the scope and purview of the invention as defined by the appended claims.

We claim:

1. A method of forming a double nickel shell mold comprising: depositing a first nickel shell on a mandrel having a desired mold shape by nickel vapor deposition, whereby the first nickel shell acquires the shape of the mandrel, bending at least one fluid line to the shape of the nickel shell and attaching said fluid line to the first nickel shell, and depositing a second nickel shell onto the first nickel shell for encapsulating the at least one fluid line between the first and second nickel shells.

2. A method as claimed in claim 1 in which the fluid line is a copper or stainless steel tube.

3. A method as claimed in claim 1 additionally comprising filling any cavity between the fluid line and the first nickel shell with a thermoplastic filler consisting of a mixture of at least one of particulate copper, aluminum, steel shot or powder in a polymer matrix selected from the group consisting of silicones, epoxies, urethanes, fluoropolymers and acrylics.

4. A nickel shell mold comprising:
a first nickel shell conformed to a desired product shape by nickel vapor deposition onto a mandrel;
at least one fluid line for a heat transfer fluid attached to the first nickel shell; and
a second nickel shell deposited by nickel vapor deposition onto the first nickel shell encapsulating said at least one fluid line.

5. The nickel shell mold as claimed in claim 4 wherein any space defined between the first nickel shell and the fluid line is substantially filled with a thermally conductive filler.

6. The nickel shell mold as claimed in claim 4 wherein the at least one fluid line is attached to the first nickel shell by an anchor.

7. The nickel shell mold as claimed in claim 6 wherein the anchor is secured by a weld to the first nickel shell.

8. The nickel shell mold as claimed in claim 4 wherein the thermally conductive filler is a mixture of at least one of particulate copper, aluminum, steel shot or powder in a polymer matrix selected from the group consisting of silicones, epoxies, urethanes, fluoropolymers and acrylics.
